(19) United States
(12) Patent Application Publication
(10) Pub. No.: US 2021/0181009 A1
(43) Pub. Date: Jun. 17, 2021

(54) MEASURING FLUID LEVEL IN TANK WITH COMPLEX GEOMETRICAL SHAPE

(71) Applicant: Rolls-Royce Corporation, Indianapolis, IN (US)

(72) Inventors: John Gebhard, Fishers, IN (US); Adam Kempers, Indianapolis, IN (US); Jeremy Gallagher, Carmel, IN (US)

(73) Assignee: Rolls-Royce Corporation, Indianapolis, IN (US)

(21) Appl. No.: 16/710,606

(22) Filed: Dec. 11, 2019

(51) Int. Cl. G01F 23/70; F16N 19/00

(52) U.S. Cl. CPC G01F 23/70; F16N 19/003

(57) ABSTRACT

A system and method for efficiently measuring the fluid level in a container having a non-uniform cross sectional area is described. The measuring device may be immersed in the fluid and have a float slidable along a structure having the capability to sense an aspect of the location of the float. Since the accuracy requirements in measuring the fluid level may be more important for the higher levels and the lower levels than the intermediate quantities, the sensor may likewise be configured to provide more accurate measurements near the upper and lower fill levels. The position of a float may be determined by capacitive optical or magnetic sensing techniques and the sensed position translated into engineering units for output by a calibration table.

### TECHNICAL FIELD

This disclosure relates the measurement of the level of a fluid in a vessel having an irregular shape.

### BACKGROUND

Fluid containers may be used, for example to supply oil to various components of an engine. To achieve the necessary fluid volume the containers may be formed in unconventional shapes so as to permit installation in confined and possibly inaccessible locations. A particular application is in a gas turbine engine.

Gas turbine engines may include a compressor, a combustor and a turbine. Typically, the compressor is an air compressor rotating on a longitudinal shaft of the engine to provide air for the combustion cycle. The air is provided to the combustor along with fuel where combustion occurs to create a high pressure, high temperature flow, which is provided to the turbine. The turbine may provide mechanical torque to the shaft and provides exhaust gas that creates thrust. The gas turbine engine typically includes bearings, such as shaft bearings that allow the shaft to rotate. Such bearings may be lubricated by bearing oil. The bearing oil may be distributed to one or more bearings from an oil sump(s). Seals may be used to stop leaking of the bearing oil around the shaft or other rotating parts of the gas turbine engine. An oil scavenge system may return bearing oil to the oil sump(s). The location and cross-section and overall configuration of such an oil tank may be constrained by the geometry of the turbine and associated air guiding structures. Other liquid storage reservoirs may encounter space restrictions where the disclosed technology may be useful.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a longitudinal cross-sectional view of an example of a gas turbine engine, with an example location of an oil reservoir;

FIG. 2 is a simplified transverse cross-section view (looking forward) of a portion of an example gas turbine engine of FIG. 1 illustrating the example location of the oil reservoir;

FIG. 3 A is a transverse cross-sectional view of an arcuate vertical support adapted to guide a float having a compatible cross section and radius of curvature;

FIG. 3B is a transverse cross-sectional view of a float body having a cross section compatible with the support of FIG. 3A;

FIG. 3C is a longitudinal cross-sectional view of the float body of FIG. 3B where the radius of curvature conforms to the radius of curvature of the vertical support;

FIG. 4A is an example of a structure having a plurality of capacitive-sensors, where several different linear dimensions are used;

FIG. 4B is an elevation and cross-sectional view of a float body similar to that of FIG. 3B having a metal plate for forming a capacitor with the capacitive sensors of FIG. 4A;

FIG. 4C is an elevation view showing the relationship of the float assembly with respect to the structure of FIG. 5A as the float moves along the structure;

FIG. 5A illustrates the conceptual relationship between an actual fluid level in a reservoir and the output of the capacitive sensor array as the fluid level changes;

FIG. 5B illustrates the relationship between the oil gauge output of 5A and the actual quantity of oil in the reservoir;

FIG. 6A is an example of a structure having a plurality of optical retroreflective sensors, where several different linear dimensions are used for the separation between sensors;

FIG. 6B is an elevation and cross-sectional view of a float body similar to that of FIG. 4B having a reflective strip extending along a vertical dimension thereof; and

FIG. 6C is an elevation view showing the relationship of the float assembly with respect to the structure of FIG. 6A as the float moves along the structure.

### DETAILED DESCRIPTION

In an example, the vessel may be an oil reservoir that is located between the inner portion of a fan duct and the outer housing of the turbine portion of a gas turbine engine. Other locations are not intended to be excluded. The location of the oil reservoir may be constrained by the other aspects of the engine design such that direct access to the oil reservoir is either difficult or not feasible without disassembly. Often the design requirements for ancillary equipment may be constrained by the requirements of the remainder of the power plant. Oil may be added to the reservoir using a filler pipe or pressurized oil supply to make up for oil consumed during operation. To do this, the level of oil in the reservoir needs to be determined, and the oil re-supply operation should not result in overfilling of the reservoir.

In another example, the oil reservoir may be formed with a pair of arcuate opposing sides so as to increase the angular length of the oil reservoir when the reservoir is located, for example, to approximately conform with the radius of curvature of an interior part of the engine assembly. The device used to measure the oil level over a significant portion of the volume of the oil reservoir may have an arcuate shape as well so as to permit the length dimension of the device to be incorporated into the oil reservoir without interference with the walls thereof. The oil reservoir also be known as an oil tank, or similar name.

In an example, oil level measuring device, or oil gauge, is described, substantially conforming to the to the curvature of the reservoir itself and comprises a arcuate support structure, a float adapted to be guided along the support structure, and an electrical quantity sensor. This structure is intended to represent a situation where the cross sectional area of the reservoir varies along the height or vertical direction thereof, so that the relationship of the quantity of fluid in the reservoir and a height of the fluid in the reservoir may not be linear. However, this aspect is not intended to exclude a measuring device having a straight profile in the height dimension.

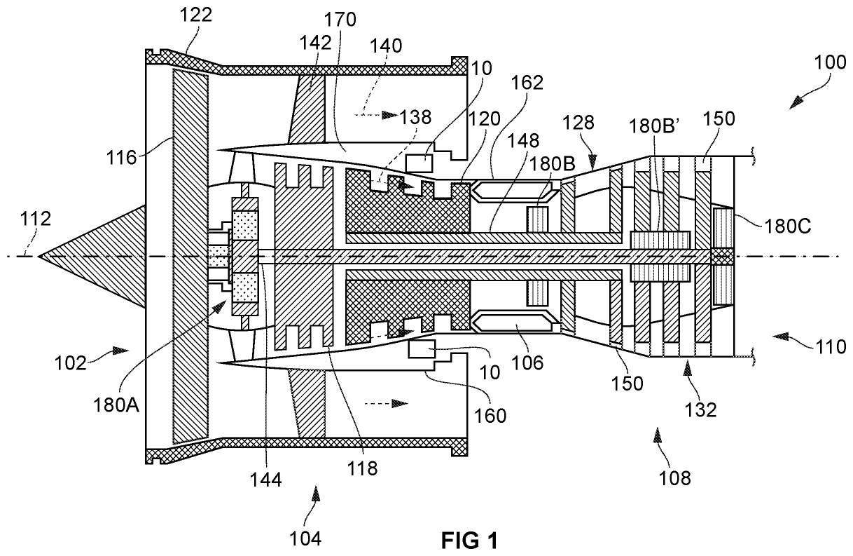

FIG. 1 is a cross-sectional view of an example of a gas turbine engine 100. The gas turbine engine 100 may, for example, supply power to and/or provide propulsion of an aircraft. Examples of the aircraft may include a helicopter, an airplane, an unmanned space vehicle, a fixed wing vehicle, a variable wing vehicle, a rotary wing vehicle or the like. In other examples, the gas turbine engine 100 may be utilized in a configuration unrelated to an aircraft such as, for example, an industrial application, an energy application, a power plant, a pumping set, a marine application (for example, for naval propulsion), a weapon system, a security system, a perimeter defense or security system.

The gas turbine engine 100 may take a variety of forms in various embodiments. Although depicted in the example of FIG. 1 as a ducted axial-flow engine with multiple spools, in some forms the gas turbine engine 100 may have additional or fewer spools and/or may be a centrifugal or mixed centrifugal/axial flow engine. In some forms, the gas turbine engine 100 may be a turboprop, a turbofan, or a turboshaft engine. Furthermore, the gas turbine engine 100 may be an adaptive cycle and/or variable cycle engine. Other variations are also contemplated. Other engine types may also employ a fluid tank where remote quantity measurement is desired.

The gas turbine engine 100 may include an air intake 102, multistage axial-flow compressor 104, a combustor 106, a multistage turbine 108 and an exhaust 110 concentric with a central axis 112 of the gas turbine engine 100. The multistage axial-flow compressor 104 may include a fan 116, a low-pressure compressor 118 and a high-pressure compressor 120 disposed in a fan casing 122. The multistage turbine 108 may include a high-pressure turbine 128 and a low-pressure turbine 132.

A low-pressure spool includes the fan 116 and the low-pressure compressor 118 driving the low-pressure turbine 132 via a low-pressure shaft 144. A high-pressure spool includes the high-pressure compressor 120 driving the high-pressure turbine 128 via a high-pressure shaft 148. In the illustrated example, the low-pressure shaft 144 and the high-pressure shaft 148 are disposed concentrically in the gas turbine engine 100. In other examples, other shaft configurations are possible.

During operation of the gas turbine engine 100, fluid received from the air intake 102, such as air, is accelerated by the fan 116 to produce two air flows. A first air flow, or core air flow, travels along a first flow path indicated by dotted arrow 138 in a core of the gas turbine engine 100. The core is formed by the multi-stage axial compressor 104, the combustor 106, the multi-stage turbine 108 and the exhaust 110. A second air flow, or bypass airflow, travels along a second flow path indicated by dotted arrow 140 outside the core of the gas turbine engine 100 past outer guide vanes 142.

The first air flow, or core air flow, may be compressed within the multi-stage axial compressor 104. The compressed fluid may then be mixed with fuel and the mixture may be burned in the combustor 106. The combustor 106 may include any suitable fuel injection and combustion mechanisms. The resultant hot, expanded high-pressure fluid may then pass through the multi-stage turbine 108 to extract energy from the fluid and cause the low-pressure shaft 144 and the high-pressure shaft 148 to rotate, which in turn drives the fan 116, the low-pressure compressor 118 and the high-pressure compressor 120. Discharge fluid may exit the exhaust 110.

The first air flow 138 and the second air flow 140 are coaxial and are confined and separated from each other by a structure comprising the fan casing 122 and an outer compressor case 160 and the outer case 162 of the multi-stage compressor 118,120. A void 170 may exist between the compressor case 160 and the outer case 162 where auxiliary equipment such as an oil reservoir 10, shown in cross section, may be provided, using this otherwise empty space.

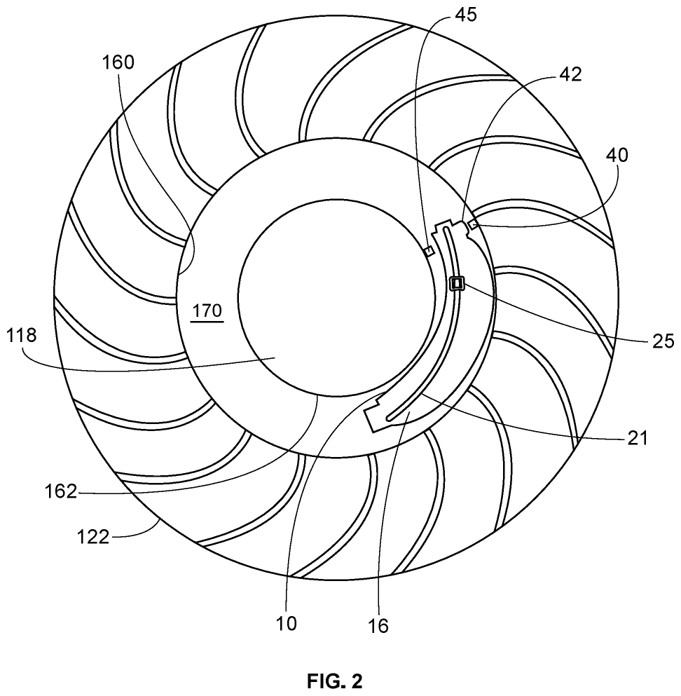

In an aspect, FIG. 2 is a simplified transverse cross-section view (looking forward) of a portion of an example gas turbine engine of FIG. 1 illustrating a the location of the oil reservoir 10 with respect to the outer compressor case 162 and the outer case 162 of the engine core, which may the multi-stage compressor or high pressure turbine 128. In this example, the oil reservoir 10 is disposed along an arcuate side portion of the void 170 created by the walls 160 and 162. Details of the mounting arrangement are not shown as they depend on the engine specific design. However, the oil reservoir 10 may be fixedly attached to a wall 160 or 162.

The reservoir 10 may comprise arcuate surfaces opposing the walls 160 and 162 where the radius of curvature of the walls of the reservoir are selected to conform to the general radius of curvature of the void 170, facilitating installation of a reservoir 10 of a desired capacity in a confined space. The radius of curvature may vary as part of the detailed design of the oil reservoir 10, taking into account the required fluid volume, the shape of the oil measurement device 15, mounting and fluid feeding arrangements, the location other equipment such as a sight glass 42 or a camera device 40, if any.

An oil level sensor assembly may comprise a float assembly 15, captivated to an oil sensor assembly 20 having an arcuate support structure 21 so that the float assembly 15 may slide freely along at least a portion of the length of the arcuate support structure 21, which may be attached to an inner wall 16 of the oil reservoir 10.

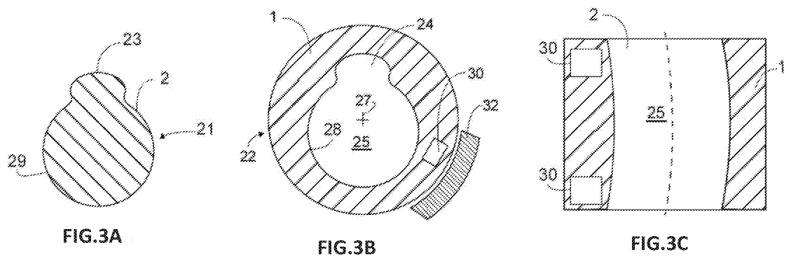

In an example, the oil measuring device 20, which may be termed an oil gage, fluid level sensor or the like, may be comprised of the central arcuate supporting structure 21, shown in cross-section in FIG. 3A, which may be a rod, a column or a beam which may be solid or hollow, and having a shape in cross section that cooperates with a similarly-shaped complimentary surface of an aperture in a float 22 so as to rotationally captivate the float 22 to the central supporting structure 21. As shown in FIG. 3A, the rod 21 has a protuberance or tongue 23 which renders the rod 21 rotationally asymmetric. FIG. 3B is an example of a cross section of a float 22 compatible with the rod 21, where the central opening 25 of the float 22 is sized and dimensioned to slide without binding to the rod 21 when moving in a direction parallel to the axis of the rod 21. A gap between the inner surface of the central opening 25 and the outer surface 29 of the rod 21 is sized to permit fluid to penetrate the gap to provide lubrication.

The central axis 27 of the aperture 25 of the float has a radius of curvature determined by that of the rod 21 so that, the float 22 may move vertically in the oil reservoir 10 along the rod 21 without binding. The float 22 may be a solid such as a suitable plastic or similar material, composite material or a hollow structure fabricated from a metal or the like, that has an effective specific gravity that is less than that of the liquid to be measured, such that a top surface of the float 22 protrudes above that of the corresponding liquid. The length of the float 22 in the direction parallel to the direction of motion is selected to contain the element that is sensed to determine the position of the float 22 along the rod 21, and is sufficient to provide the needed buoyancy.

In an aspect, one or more elements 30 whose position may be sensed may be mounted on or embedded within the float 22 and positioned such that the element to be sensed opposes a plurality of sensor elements disposed along at least a portion of the length of the rod 21. The sensing elements may be in a structure 32 that lies outside the periphery of the float 22, or is inside the rod 21 or on the surface 29 thereof. When the sensing elements are disposed in a structure outside the surface 29 of the float 22 on an arcuate structure 32 generally conforming to the rod, a spacing sufficient to avoid binding or deleterious viscous effects is selected. Since the sensor does not need to be in contact with the element to be sensed, this spacing is a matter of design, taking account of the particular sensing technique and fluid properties.

So long as the inner surface 28 of the float 22 and the outer surface 29 of the rod 21 conform such that a float 22 does not bind to the rod 21, the specific details of this aspect of the structure may be selected based on other considerations. The cross-section of the central opening 25 may be a tongue 24 as shown, an oval, a rectangle, a square or the like. Further, the upper and lower extremities of the central opening 25 may be relieved with respect to the rod 21 so as to minimize frictional forces.

Examples of the element to be sensed are magnetic field from a permanent magnet, a capacitance, a reflected light, or a ferrous metal. The gauge may permit the oil quantity to be measured either in-flight or on-the-ground over a desired range of fill levels so as to determine the rate of consumption of oil and to monitor the filling or re-filling of the tank.

In another example, the oil reservoir may have a shape that permits the use of a sensor device that has a straight vertical aspect, but the sensor may be inclined to the vertical so as to extend along the vertical dimension of the oil reservoir and provide oil level measurements for the desired range of fill levels of the tank, and to provide information on oil consumption rates, or the like.

In each example, the relationship between sensor output indications and the fill level, in liquid measure, may be non-linear, but monotonic. Further, the operational use and manufacturing cost of the oil level sensor may benefit from an oil level measurement device where the sensitivity to oil level change differs along the vertical dimension of the device. This may be combined with a computer-aided linearization technique where quantitative measurements are needed, such as near the top or the bottom of the reservoir. The non-linear characteristic may be a result of the differing cross-sectional area of the reservoir along in the vertical dimension thereof, or a non-linear effective spacing of sensing elements to reduce the number of sensing elements to lower the cost or increase the reliability of the device.

Such measurements may be used to guide servicing personnel in ramp-level maintenance so as to avoid overfilling of reservoir, to indicate excessive oil consumption in flight and to provide a low-fluid-level alert as part of avionics health measurement. In circumstances where the oil may be replenished in flight from another source, the measuring device may be used to alert the flight crew to the necessity to perform the operation, or perform and control the operation automatically.

The position of the float 22 along the vertical dimension of the supporting structure 21 may be sensed by magnetic techniques as discussed above.

In another example of sensing the level of the float in the liquid, a capacitive sensor assembly may be used. This may be facilitated by mounting one or more metal elements on or near the surface of the vertical portion of the float so as to change the capacitance of capacitors incorporated into the structure 50. The electronic elements needed for sensing may be provided on circuit board 51 forming the capacitors.

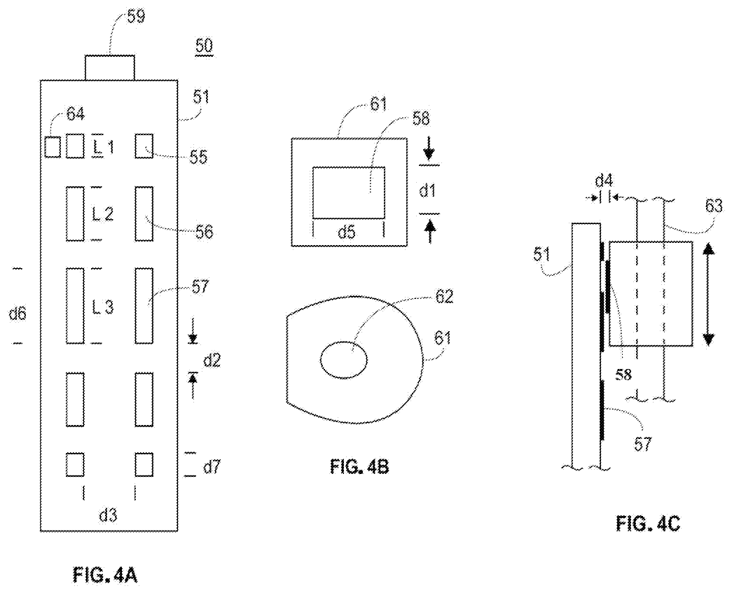

FIGS. 4A-4C illustrate an example of a capacitive sensor 50 suitable for use in the present context. For simplicity, the geometry is shown as generally planar and linear; however, one may appreciate that the geometry of the surfaces of the sensor elements may be curved, to conform to the overall geometry of the reservoir such as the arcuate shaped reservoir 10. In the context of FIGS. 2 and 3A-C, the float, 61 of FIG. 4B and FIG. 4C corresponds to the float 22 of FIG. 2, FIG. 3B and FIG. 3C, and a similar correspondence is found between the sensor support structures (32, 51), and the aperture in the float (25, 62), respectively, at least in functional terms.

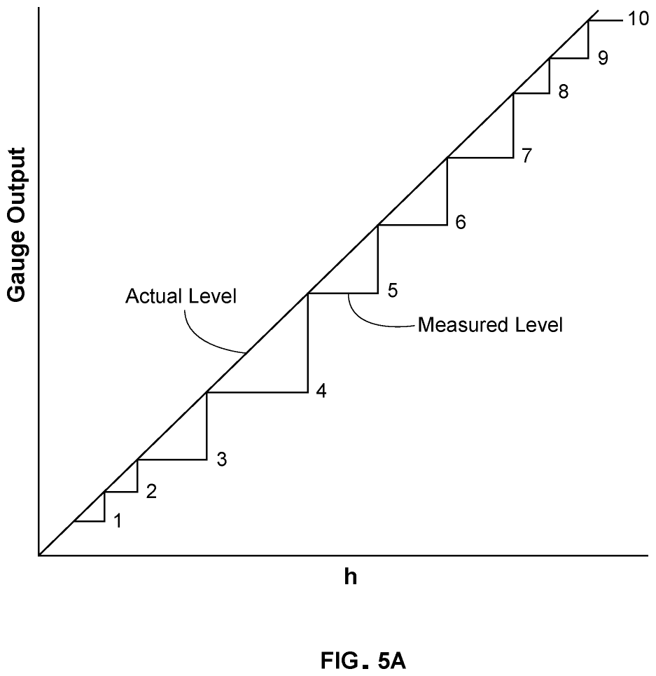

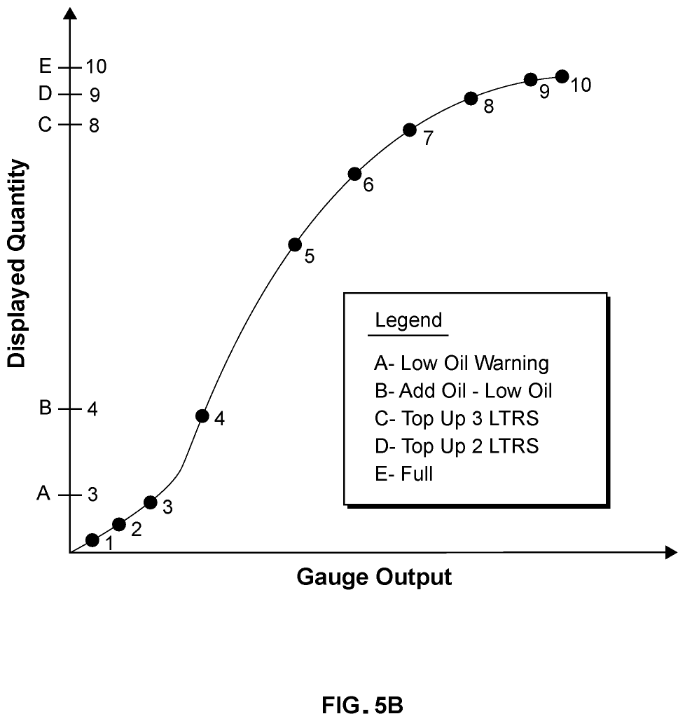

A capacitive oil-level-measurement device may comprise sensor support structure 51, which may be a printed wiring assembly or the like, in whole or in part, having mounted thereon or embedded therein a plurality of pairs of metal plates, 55, 56, 57 each pair of the plurality of pairs may be of the same physical dimensions; alternatively, the physical dimensions of the metal plates may vary along the length of the substrate 51. Several examples of differently sized metal plates are shown in FIG. 5A, and the length of each pair may be determined based on the measurement accuracy requirements. One or more electronic circuits 64 may be provided having a capacitance measurement capability. Such a capacitive measurement device may be provided with a DC power supply, or circuitry to convert an AC power source to DC to operate the circuitry configured to measure the capacitance of pairs of plates 55, 56, 57 and to provide an indication of the value of the capacitance with respect to a predetermined threshold value for each of the pairs of plates. When a float 61 is disposed as in FIG. 4B and FIG. 4C, as an example, the vertical location the float will change with respect to the pairs of metal plates 55, 56, 57. The float 61 may have a metallic plate 58 or conductive surface which may be, for example, a conductive tape or plating, having a vertical dimension d1 attached to or embedded in the float and disposed so as to conform to any curvature of the substrate 51 and separated from the substrate 51 by a distance d4 by the remaining structural elements (not shown) and perhaps by ridges on the float 61 or the substrate 51. Adjacent pairs of metal plates 55, and 56 or 56 and 57, for example, are separated in a vertical direction by a distance d2 and by a horizontal distance d3. The dimension d1 of the plate 58 is greater than any dimension d2, and the dimension d5 of the plate 58 is greater than the separation d3 between pairs of plates on the substrate 51 so that the plate 58 overlaps a pair of capacitive elements (e.g. 57).

Where the term “vertical” is used, the direction is that in which the surface of a fluid in the reservoir changes in response to a change of fluid quantity in the reservoir, and may represent a motion or direction along a support 32 having a radius of curvature.

The dielectric constant of typical lubricating oil between about 2.1 and about 2.8 and the dielectric constant of typical substrates used in the manufacture of printed circuit boards is between 2.1 and 4.5 whereas the dielectric constant of air is 1.0.

In an example, the configuration of the pairs of metal plates 55, 56, 57 is such that the edges of the plates oppose each other and the plates lie in a common plane, rather than the conventional arrangement of a capacitor where the flat surfaces of the metal plate would oppose each other, separated by a small distance. In the present circumstance, a capacitance exists between each of the pairs of plates that is a consequence of the fringing electric field between the two plates. In most electronic circuits this capacitance is considered undesirable and a design usually minimizes the “fringing capacitance” with respect to the desired design value. In more complex electronic circuits reducing the fringing capacitance also has the effect of minimizing potential spurious resonance effects at frequencies that are remote from the design frequency of the circuit, or minimizes coupling of energy between unrelated parts of an electronic circuit. Here, the fringing capacitance is a small capacitance that is measured when the sensed plate 58 is not in proximity to the corresponding pair of plates (e.g., 56) on the substrate 51.

In this example, the float 61 is provided with a metal plate 58 disposed a distance d4 from the substrate 51 upon which the pairs of plates 55, 56, 57 are positioned. When the plate 58 fully opposes a pair of plates such as 55, the combination pair of plates 55 and the metal plate 58 on the float 61 forms a capacitor C having a capacitance substantially greater than the fringing capacitance between two adjacent plates on the substrate 51 and, from an equivalent circuit viewpoint, connected in parallel with the fringing capacitance. The capacitance measuring circuit 64 may measure capacitance by determining, for example, a change in impedance, or resonant frequency, of an electronic circuit utilizing the arrangement of the pair of metallic plates such as 56 and the metallic plate 58 as a capacitive circuit element.

A threshold capacitance value may be established for each of the pairs of metal plates 55, 56 and 57 so that when the metal plate 58 on the float 61 opposes one or more of the pairs of metal plates 55, 56, 57, the change in capacitance is detected and reported through an interface 59. This may be a switch closure indication (that is, a binary signal) or the uppermost of multiple simultaneous switch closures as a value associated with the position of the float 61. Since the height d1 of the plate 58 on the float 61 is greater than the vertical distance d2 between adjacent pairs of longitudinally disposed sensing elements when the fluid level is transitioning in height between the adjacent plates there is no loss of sensing capability.

Where the accuracy of measurement of oil level is intended to be low, the capacitive plates may have the configuration shown as 57, where the height d1 of the metal plate 58 on the float 61 is less than the height L3 of the metal plates 57. So, when the plate 58 on the float opposes the pair of metal plates 57, the capacitance change is detected only on the measuring circuit associated with the pair of plates 57 corresponding to the coincidence in height of the plates, except during a transition state between adjacent vertically disposed pairs of plates (e.g., 56, 57). The resolution of this measurement is correspondingly low and an indicated level may not change until the float level changes in height so as to oppose either a higher or lower pair of plates. Provided that the height d1 of the metal plate 58 on the float 61 is at least greater than the vertical separation distance d2 between adjacent metal plates, the measurement sequence is continuous. The height of the metal plate d1 may be greater than the height (e.g., L1) of some of the smaller dimensioned pairs of plates so that more than one of the smaller dimensioned plates detects a capacitive change in an overlapping manner. A data processing algorithm may then determine the value to be displayed. In such an instance, for example, the uppermost pair of plates so activated represents the height of the fluid near the top of the reservoir and the lowermost pair of plates represents the height of the fluid near the bottom of the reservoir. This description should not be construed as limiting the device to a configuration where the plates 55, 56 and 57 have different vertical dimensions.

FIG. 5A shows an example output for a hypothetical case where the amount of oil in the reservoir is linearly proportional to the height of the float, and the ratio of the vertical lengths L1, L2, L3 is 1:2:3. The state of each of the capacitive sensors is shown, where a solid line indicates an output. The state during the transition from adjacent sensors is not shown, but is at least either of the two adjacent states depending on the processing algorithm. The measured output is generally a stair-step function approximating the fluid level with the granularity of the measurement dependent on the relative dimensions of the capacitive elements of the sensor and the sensed element on the float.

In the circumstance where the volume of oil in the reservoir is not linearly related to the height of the float, such as where the cross-section of the reservoir varies with height, a conversion factor between output indications and oil quantity may be adjusted in accordance with a predetermined factor in each case. For more accurate measurements, the temperature of the oil may be measured using an electronic sensor and a further correction made.

FIG. 5B shows a representative relationship between the gauge output reading (abscissa) and the actual fluid amount (ordinate). The individual sensed readings may be converted into numerical fluid quantities for reporting or display or may be associated with literal terms meant to prompt servicing action. Where the oil reservoir is automatically replenished, the indicated actions may be initiated without operator intervention.

Other capacitive sensor arrangements may be made, where a complimentary approach employing apertures in a metal surface instead of the metal surface on a dielectric surface may be employed. In another aspect, a single vertical columnar arrangement of metal single plates 55, 56, 57, rather than the pairs of plates shown in FIG. 5A, may be employed and the capacitance between pairs of adjacent metal plates (e.g. 56, 57) in a vertical direction may be used. In this instance the capacitance is measured pairwise in the vertical direction.

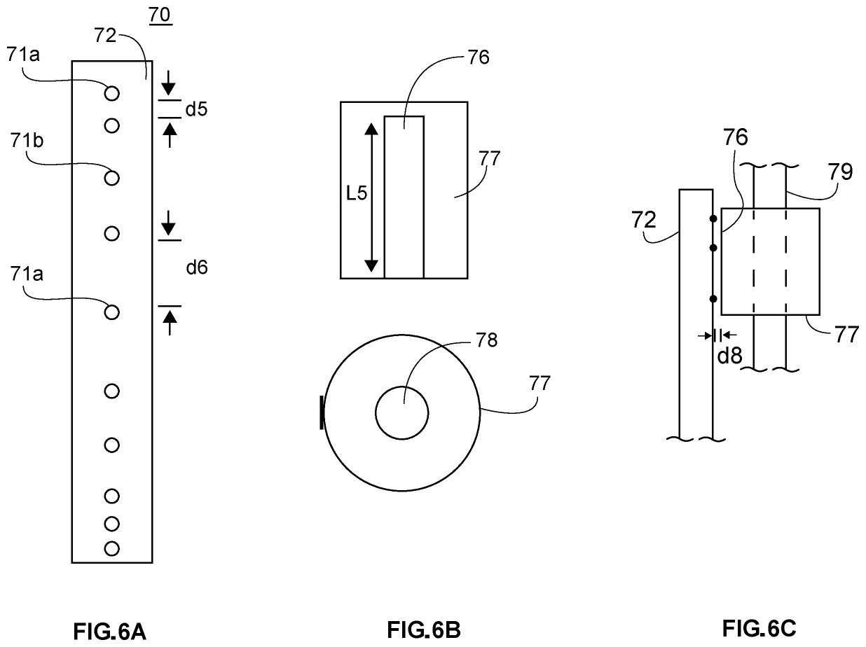

In still another aspect, the location of the float may be sensed using other proximity sensing techniques such as a photoelectric retroreflective sensor, a discrete capacitive sensor, an inductive type proximity sensor, or the like. A representative example of such an arrangement 70 is shown in FIG. 6A-C. The individual sensors 71 are mounted on a support 72 such that the sensitive portion of the sensor 71 opposes a portion 76 of the float 77 to be sensed. The portion to be sensed, 76, may be, for example, one of a diffuse or miniature retro-reflector array, which may be a tape or other strip of reflective material in the case of a photoelectric sensor, a metal strip, or a plurality of magnetic layers, each of the sensed elements extending over a vertical length L5. The spacing between the sensors 71 may be a variable distance such as d5, d6 where the length of the sensed element 76 is at least greater than the maximum vertical distance between adjacent sensors. This ensures that at least one of the sensors 71a, 71b, 71c, . . . is activated at all times that the level of the float 77 is within the range of the measuring device 70.

In a similar manner to the embodiment of FIG. 4, the granularity of the measurement is governed by the maximum and the minimum spacing distances that have been selected. Where more than one of the sensors 71a-n are activated at one time, the sensed float level may be represented by the uppermost of the activated sensors 71 when the float is above the low sensitivity region and the lowermost of the activator sensors 71 when the float is below the low sensitivity region. The displayed oil level may then be corrected for any non-linear relationship between the detected oil level and the quantity of oil represented by the corresponding level of the float.

The subject-matter of the disclosure may also relate, among others, to the following:

1. In an aspect a device for measuring the level of a fluid in a container, comprises:

a structure having a plurality of sensing elements mounted along a vertical direction thereof; and

an object to be sensed, constrained to move along the vertical direction of the structure in response to a change in fluid level and spaced apart therefrom,

each sensing element capable of detecting the object to be sensed when a sensed portion of the object is disposed so as to oppose the sensing element; and the object to be sensed is configured to be sensed by at least one sensing element.

2. The device of aspect 1, wherein the status of each sensing element is determined by a processor and the processor executes a program stored in a non-volatile computer readable medium to:

determine that one or more of the sensors has sensed the sensed portion of the object; and

select a location value to be output,

wherein the location value to be output is a vertical location of the sensor when a single sensor has sensed the object to be sensed; or, when more than one sensor has sensed the object, the location value is a vertical location of the sensor that has sensed the object and is closest to an end of the structure.

3. The device of aspect 1, wherein a relationship between a location along the vertical direction and a quantity of fluid is determined for a reservoir in which the structure having the sensors is fixedly mounted, and a location value to be output is converted to a fluid quantity using a predetermined relationship between a sensor output of the sensing element and a fluid quantity at the location of the sensing corresponding to the location value output.

4. The device of aspect 1, wherein the relationship between the location value output by the sensing element and a quantity of fluid in the reservoir is determined and stored in the non-volatile memory.

5. The device of aspect 2, the discrete sensor further comprises:
a plurality of pairs of metal plates arranged on or near a surface of the structure, where the structure is a non-conducting material and the object to be sensed has a metallic strip constrained to be movably disposed opposite the plurality of discrete sensors and having a length extending in the transverse direction of the structure.

6. The device of aspect 5, wherein the discrete sensor comprises pairs of metal plates spaced apart in the vertical direction of the structure by a variable linear spacing; and a capacitance value of each of the pairs of metal plates is measured by a processor; and

the processor configured to execute computer-readable instructions stored in a non-volatile memory to determine a state of the pair of metal plates based on a comparison of measured capacitance value with a capacitance value threshold for each of the pairs of metal plates.

7. The device of aspect 2, wherein a plurality of metal plates is arranged in a column along the vertical direction of the structure by a variable spacing; and the processor measures a capacitance of adjacent metal plates in the column; and

a state of each of the pairs of adjacent metal plates is determined by the processor based on a comparison of the measured capacitance of each pair of the adjacent metal plates with a capacitance threshold for each adjacent pair of metal plates in the column.

8. The device of aspect 3, wherein the discrete sensor is a retro-reflective optical sensor and the element to be sensed is a diffuse reflector or a retroreflector strip.

9. The device of aspect 8, wherein the element to be sensed is a linear strip adhered to the object to be sensed.

10. In another aspect. a method of determining the level of a fluid in a reservoir, comprises:
providing a structure having a plurality of discrete sensing elements mounted along a vertical direction;
providing an object to be sensed, constrained to move along the vertical direction of the structure and spaced apart therefrom, the object having a smaller specific gravity than the specific gravity of the fluid; and
a processor configured to execute a program stored in a non-volatile computer-readable medium,
wherein a linear spacing between the adjacent discrete sensing elements along the vertical direction is varied between an upper distance limit and a lower distance limit; and a sensed portion of the object to be sensed has an extent in the vertical direction that is at least as great as the upper distance limit;

the method further comprises:

determining, by the processor, that one or more of the discrete sensing element has sensed the sensed portion of the object; and

outputting a location value representing a vertical position of the sensed portion of the object,

wherein the location value is a location of the discrete sensor when the sensed portion of the object is sensed by a single sensor, or the location value is the location of the discrete sensor having the smallest linear spacing to an adjacent sensor and closest to an end of the support when the sensed portion of the object is sensed by more than one sensor.

11. The method of aspect 10, further comprising:

determining a relationship between the location value and a volume quantity of the fluid in the reservoir; and

converting the location values to engineering units to be output.

12. The method of aspect 10, further comprising determining a relationship between the location value and the quantity of the fluid in the reservoir; and

converting the location value to alphanumeric indications.

13. The method of aspect 10, further comprising:
setting a predetermined maximum level of fluid permitted in the reservoir and a predetermined minimum level of fluid permitted in the reservoir; and
the processor configured to control adding fluid to the reservoir when the minimum level of fluid is determined and to cease adding fluid to the reservoir when a maximum level of fluid is determined.

14. The method of aspect 10, wherein the sensor further comprises:
a plurality of pairs of metal plates arranged on or near a surface of the structure non-conductive structure, and where the object to be sensed comprises a metal strip constrained to move in a vertical direction corresponding to a level of the fluid, dimensioned such that when the metal strip is disposed opposite the pair of metal plates, the metal strip opposes both of the plates of the pair of plates.

15. The method of aspect 10, wherein the sensor comprises pairs of metal plates spaced apart in a direction transverse to the vertical direction of the structure by the variable linear spacing; and a capacitance value of each of the pairs of metal plates is measured by a processor; and

the processor configured to execute computer-readable instructions stored in a non-volatile memory to determine a state of the pair of metal plates based on a comparison of measured capacitance value with a capacitance value threshold for each of the pair of metal plates.

16. The method of aspect 10, wherein the sensor comprises metal plates spaced apart in a column in the vertical direction of the structure spacing; and a capacitance value of each of the pairs of metal plates in the column, taken as a pair, is measured by a processor; and

the processor configured to execute computer-readable instructions stored in a non-volatile memory to determine a state of the pair of metal plates based on a comparison of measured capacitance value with a capacitance value threshold for each of the pair of metal plates.

To clarify the use of and to hereby provide notice to the public, the phrases “at least one of <A>, <B>, . . . and <N>” or “at least one of <A>, <B>, <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

1. A device for measuring a level of a fluid in a reservoir, comprising:
a structure having a plurality of sensor elements mounted along a vertical direction thereof; and
an object to be sensed, constrained to move along the vertical direction of the structure without binding in response to a change in fluid level in the reservoir and spaced apart therefrom,
each sensing element of the plurality of sensor elements capable of detecting the object to be sensed when a sensed portion of the object is disposed so as to oppose the sensing element; and the object to be sensed is configured to be sensed by at least one sensor element,
wherein the structure has an arcuate shape and is sized and dimensioned to mount internal to the reservoir, the reservoir comprising a first arcuate surface whose radius of curvature conforms to a radius of curvature of an adjacent first cylindrical surface and a second arcuate surface whose radius conforms to a radius of curvature of an adjacent second cylindrical surface.

2. The device of claim 1, wherein a status of each sensing element is determined by a processor and the processor executes a program stored in a non-volatile computer readable medium to:
determine that one or more sensor elements of the plurality of sensor elements has sensed the object; and
select a location value to be output,
wherein the location value to be output is a vertical location of the sensor element when one of the plurality of sensor elements has sensed the object to be sensed; or, when more than one sensing element of the plurality of sensing elements has sensed the object, the location value is a vertical location of the sensor element of the plurality of sensor elements that has sensed the object and is closest to an end of the structure.

3. The device of claim 1, wherein a relationship between a location along the vertical direction and a quantity of fluid is determined for the reservoir in which the structure having the plurality of sensor elements is fixedly mounted, and a vertical location value to be output is converted to a fluid quantity using a predetermined relationship between a sensor output of the sensor element and a fluid quantity at the location of the sensing corresponding to the location value output.

4. The device of claim 1, wherein a relationship between a vertical location value and a quantity of fluid in the reservoir is determined and stored in a non-volatile memory.

5. The device of claim 2, wherein the sensing element further comprises:
a plurality of pairs of metal plates arranged on or near a surface of the structure, where the structure is a non-conducting material and the object to be sensed has a metallic strip constrained to be movably disposed opposite the plurality of sensing elements and having a length extending in a transverse direction of the structure.

6. The device of claim 5, wherein the pairs of metal plates are spaced apart in the vertical direction of the structure by a variable linear spacing; and a capacitance value of each of the pairs of metal plates is measured by a processor; and
the processor configured to execute computer-readable instructions stored in a non-volatile memory to determine a state of the pair of metal plates based on a comparison of measured capacitance value with a capacitance value threshold for each of the pairs of metal plates.

7. The device of claim 2, wherein a plurality of metal plates is arranged in a column along the vertical direction of the structure by a variable spacing; and the processor measures a capacitance of adjacent metal plates in the column; and
a state of each of pairs of adjacent metal plates of the plurality of metal plates is determined by the processor based on a comparison of the measured capacitance of each pair of adjacent metal plates with a capacitance threshold for each adjacent pair of metal plates in the column.

8. The device of claim 3, wherein the sensor element is a retro-reflective optical sensor and the element to be sensed is a diffuse reflector or a retroreflector strip.

9. The device of claim 8, wherein the element to be sensed is a linear strip adhered to the object to be sensed.

10. A method of determining a level of a fluid in a reservoir, comprising:
providing a structure having a plurality of sensor elements mounted along a vertical direction,
wherein the structure has an arcuate shape and is sized and dimensioned to mount internal to the reservoir comprising a first arcuate surface whose radius of curvature conforms to a radius of curvature of an adjacent first cylindrical surface and a second arcuate surface whose radius conforms to a radius of curvature of an adjacent second arcuate cylindrical surface;
providing an object to be sensed, constrained to move along the vertical direction of the structure and spaced apart therefrom, the object having a smaller specific gravity than a specific gravity of the fluid; and
a processor configured to execute a program stored in a non-volatile computer-readable medium,
wherein a linear spacing between adjacent sensors along the vertical direction is varied between an upper distance limit and a lower distance limit; and a sensed portion of the object to be sensed has an extent in the vertical direction that is at least as great as the upper distance limit;
the method further comprising:
determining, by the processor, that one or more of the sensor elements has sensed the sensed portion of the object; and
outputting a location value representing a vertical position of the sensed portion of the object,
wherein the location value is a location of the sensor when the sensed portion of the object is sensed by a single sensor, or the location value is the location of the sensor having a smallest linear spacing to an adjacent sensor and closest to an end of the structure when the sensed portion of the object is sensed by more than one sensor.

11. The method of claim 10, further comprising:
determining a relationship between the location value and a volume quantity of the fluid in the reservoir; and
converting the location value to engineering units to be output.

12. The method of claim 10, further comprising determining a relationship between the location value and a quantity of the fluid in the reservoir; and
converting the location value to alphanumeric indications.

13. The method of claim 10, further comprising:
setting a predetermined maximum level of fluid permitted in the reservoir and a predetermined minimum level of fluid permitted in the reservoir; and
the processor configured to control adding fluid to the reservoir when the predetermined minimum level of fluid is determined and to cease adding fluid to the reservoir when the predetermined maximum level of fluid is determined.

14. The method of claim 10, wherein a sensor element of the plurality of sensors further comprises:
a plurality of pairs of metal plates arranged on or near a surface of the structure, and where the object to be sensed comprises a metal strip constrained to move in a vertical direction corresponding to a level of the fluid, dimensioned such that when the metal strip is disposed opposite the pair of metal plates, the metal strip opposes both of the plates of the pair of plates.

15. The method of claim 10, wherein a sensor element of the plurality of sensors comprises pairs of metal plates spaced apart in a direction transverse to the vertical direction of the structure; and a capacitance value of each of the pairs of metal plates is measured by a processor; and
the processor configured to execute computer-readable instructions stored in a non-volatile memory to determine a state of the pair of metal plates based on a comparison of measured capacitance value with a capacitance value threshold for each of the pair of metal plates.

16. The method of claim 10, wherein a sensor element of the plurality of sensors comprises metal plates spaced apart in a column in the vertical direction of the structure spacing; and a capacitance value of each of pair of metal plates in the column, taken as a pair, is measured by a processor; and
the processor configured to execute computer-readable instructions stored in a non-volatile memory to determine a state of pairs of metal plates based on a comparison of measured capacitance value with a predetermined capacitance value threshold for each of pair of metal plates.
